(19) United States
(12) Patent Application Publication
(10) Pub. No.: US 2026/0046214 A1
(43) Pub. Date: Feb. 12, 2026

(54) GENERATING AND PROVIDING A DEVICE NETWORK BALANCE USER INTERFACE TO A PROVIDER DEVICE

(71) Applicant: Lyft, Inc., San Francisco, CA (US)

(72) Inventors: Desmond Adam Chun Yiu Chan, Los Angeles, CA (US); Evan Eamon Rawn, Brooklyn, NY (US); Christopher Tellez, Laguna Beach, CA (US); Andrew Jaru Vorakrajangthiti, San Mateo, CA (US); Konstantin Yevgeniy Zak, Federal Way, WA (US); Yiming Zhao, Hoboken, NJ (US)

(21) Appl. No.: 18/932,335

(22) Filed: Oct. 30, 2024

Related U.S. Application Data
(60) Provisional application No. 63/681,584, filed on Aug. 9, 2024.

(51) Int. Cl. H04L 41/14; H04L 41/22

(52) U.S. Cl. CPC H04L 41/145; H04L 41/22

(57) ABSTRACT

This disclosure describes a transportation matching system providing a device network balance user interface with an interactive map of a geographic region. In particular, in one or more embodiments the transportation matching system determines a plurality of requestor device locations for the geographic region and a plurality of provider device locations for the geographic region. Moreover, the transportation matching system provides for display in the device network balance user interface, a plurality of requestor indicators corresponding to the plurality of requestor device locations and a plurality of provider device indicators corresponding to the plurality of provider device locations.

### CROSS-REFERENCE TO RELATED APPLICATIONS

This application claims priority to and the benefit of U.S. Provisional Patent Application No. 63/681,584, filed on Aug. 9, 2024, which is incorporated herein by reference in its entirety.

### BACKGROUND

Recent years have seen significant improvements in conventional transportation systems that utilize mobile devices to coordinate across computer networks. Indeed, the proliferation of web and mobile applications has enabled requesting devices to utilize on-demand ride sharing systems to identify matches between provider devices and requestor devices and coordinate across computer networks to initiate transportation from one geographic location to another. For instance, conventional transportation systems can determine the geographic locations of provider devices and requestor devices, generate digital matches between provider devices and requestor devices, and further track, analyze, and manage pick-up, transportation, and drop-off routines through digital transmissions across computer networks. Moreover, conventional systems utilize computing devices to provide digital notifications or alerts across computer networks for provider devices within a transportation system to prompt provider devices to move to more efficient network locations. Despite these recent advances, however, conventional systems continue to exhibit a number of drawbacks and deficiencies with regard to accuracy, efficiency, security, and operational flexibility with implementing computer devices.

These, along with additional problems and issues, exist with conventional digital systems.

### SUMMARY

This disclosure describes one or more embodiments of methods, non-transitory computer-readable media, and systems that provide improved graphical user interfaces for provider devices in a transportation matching system by surfacing dynamic map elements including provider device indicators and requestor device indicators. In particular, in one or more embodiments the disclosed systems provide a device network balance user interface that includes an interactive map of a geographic region for display on a provider device. For example, in one or more implementations, the disclosed systems determine for the geographic region, requestor device locations and provider device locations. Moreover, the disclosed systems provide for display on the device network balance user interface, requestor device indicators corresponding to the requestor device locations and provider device indicators corresponding to the provider device locations. In this manner, the disclosed systems can provide transparent recommendations to provider devices.

### BRIEF DESCRIPTION OF THE DRAWINGS

The detailed description refers to the drawings briefly described below.

FIG. 1 illustrates an example overview diagram of a provider device network balancing system generating and providing a device network balance user interface for display on a provider device in accordance with one or more embodiments.

FIG. 2 illustrates an example diagram of the provider device network balancing system utilizing historical data and real-time data to determine one or more device network balance selectable elements in accordance with one or more embodiments.

FIG. 3 illustrates an example diagram of the provider device network balancing system utilizing a time threshold and a distance threshold to determine requestor device indicators and provider device indicators in accordance with one or more embodiments.

FIG. 4 illustrates an example diagram of the provider device network balancing system implementing various privacy and security measures in accordance with one or more embodiments.

FIG. 5 illustrates an example graphical user interface of the provider device network balancing system providing selectable filters in the device network balance user interface in accordance with one or more embodiments.

FIG. 6 illustrates an example graphical user interface of the provider device network balancing system providing graphical user interfaces with device network balance selectable elements and transitioning to a more granular graphical user interface in accordance with one or more embodiments.

FIG. 7 illustrates a block diagram of an environment for implementing a provider device network balancing system in accordance with one or more embodiments.

FIG. 8 illustrates an example series of acts for providing provider device indicators and requestor device indicators in accordance with one or more embodiments.

FIG. 9 illustrates a block diagram of a computing device for implementing one or more embodiments of the present disclosure.

FIG. 10 illustrates an example environment for the provider device network balancing system in accordance with one or more embodiments.

### DETAILED DESCRIPTION

This disclosure describes one or more embodiments of a provider device network balancing system 100 that provides improved user interfaces that provide dynamic transportation pickup locations and nearby provider devices to a provider device within a particular region. For instance, the provider device network balancing system 100 can surface a user interface with dynamic map elements showing locations of recent ride pickup events (e.g., within a particular time threshold) and/or locations of other provider devices within a particular region. This allows provider devices to more accurately position themselves relative to a current supply of requestor devices and a supply of provider devices across different regions (e.g., macro-positioning) and within a particular region (e.g., micro-positioning) to improve network balancing and coverage within a transportation matching system.

For instance, the provider device network balancing system 100 can surface a user interface with dynamic map elements showing locations of recent ride pickup events (e.g., within a particular time threshold) and/or locations of other provider devices within a particular region. In some embodiments, the provider device network balancing system 100 can dynamically select the time threshold and/or distance radius utilized in surfacing recent ride pickup events (e.g., based on user interaction(s) and/or the number of rides in the region). Similarly, the provider device network balancing system 100 can filter nearby provider devices based on certain factors (e.g., such as a matching mode or vehicle type). In some implementations, the provider device network balancing system 100 allows provider devices to dynamically control what information to see within a digital map (e.g., recent rides, driver devices, time efficiency metrics, driver device modes, types of transportation requests, etc.).

The provider device network balancing system 100 can also implement a variety of features to improve security for provider devices and requestor devices, including: a minimum threshold of provider devices, hashing provider device identifiers, limiting responses to send requests, limiting endpoint level requests, limiting device location queries to other devices within the same geographic region, or utilizing historical pickup locations.

In some implementations, the provider device network balancing system 100 also generates a dynamic map with regions classified based on network balance. To illustrate, in some implementations, the provider device network balancing system 100 provides a digital map with network balance elements (e.g., a device network balance selectable element in the graphical user interface with an indicator for how long the balance will persist and/or estimated wait times within the region). Based on selection of one of these elements, the provider device network balancing system 100 surfaces elements that show more detailed information regarding requestor devices (e.g., previous transportation requests) and provider devices (e.g., location of drivers) on the digital map.

As mentioned above, conventional systems suffer from a number of technical issues. For example, conventional systems often provide digital notifications or alerts to provider devices in a black-box manner. Specifically, conventional systems typically highlight a region with a general notification or flag a region for a provider device to relocate to that region. Such recommendations, however, are often inaccurate and ineffectual. Indeed, provider devices that receive generic recommendations by conventional systems often find that upon relocating to a certain region, that there is little or no improvement in network efficiency in generating transportation matches with requestor devices (e.g., inaccurate recommendations) and the provider devices also wasted resources in relocating to the recommended area. Indeed, conventional systems can provide inaccurate and/or generic digital notifications.

Relatedly, conventional systems suffer from additional efficiency problems. Indeed, conventional systems can suffer from a snowballing effect of inefficiencies (e.g., imbalanced regions) due to network imbalances. Indeed, conventional systems often suffer from an imbalance of provider devices and requestors within and across geographic areas. For instance, a certain region may have an imbalance of a high number of requestor devices and a low number of provider devices. Such imbalances lead to significant inefficiencies with implanting servers and systems. Indeed, as network imbalances increase, so do queries, communications across computer networks, time, and computer resources utilized per transportation match. As mentioned above, some conventional systems seek to use generic notifications to prompt provider devices to address these network imbalances. However, due to the black-box nature of the recommendations, conventional systems often fail to induce rebalancing across the transportation device network.

In addition, conventional systems may attempt to provide more granular details to a provider device to persuade the provider device to relocate to a different region. However, providing more granular details often results in network security issues. For instance, providing granular details may compromise the safety, security, and privacy of client devices in a transportation system.

In contrast to conventional systems, the provider device network balancing system 100 can generate and provide a device network balance user interface that improves accuracy, reliability, efficiency, security, and flexibility of implementing computing devices. For example, the provider device network balancing system 100 can provide provider device indicators that indicate current provider devices in a geographic region and requestor device indicators that indicate recent pickup locations of requestor devices transported by provider devices. As such, a provider device can analyze the provided indicators (e.g., requestor and provider indicators) and determine how to relocate within a geographic region in response to these real-time data signals.

Moreover, the provider device network balancing system 100 also provides device network balance selectable elements to indicate macro-positioning recommendations. In response to a provider device selecting a device network balance selectable element, the provider device network balancing system 100 can provide more precise, accurate data discussed above regarding real-time requestor devices and provider devices within a geographic region. In such a manner, the provider device network balancing system 100 improves the accuracy and reliability of digital notifications transmitted to provider devices across computer networks. Furthermore, these improvements in accuracy and reliability offered by the provider device network balancing system 100 also lead to improved balancing across the transportation network.

Moreover, in contrast to conventional systems which suffer from inefficiencies, the provider device network balancing system 100 can improve efficiency by providing granular detail regarding requests and provider devices in a device network balance user interface. As mentioned above, the provider device network balancing system 100 can utilize a time threshold and a distance threshold to generate provider device indicators and requestor device indicators (corresponding to device locations) to provider devices. This allows provider devices to identify improved positions within the transportation network (e.g., identifying areas of increase transportation requests with reduced provider devices) within a geographic region and across different geographic regions. By providing this unique set of transparent data to provider devices in an efficient user interface, the provider device network balancing system 100 improves network balance and coverage (e.g., as provider devices more intelligently and accurately identify network relocation opportunities). Moreover, by correcting these imbalances, the provider device network balancing system 100 can improve efficiency of implanting servers and systems by reducing queries, communications, time, and computer resources utilized per transportation match.

Further, the provider device network balancing system 100 can also address potential network security issues. As mentioned above, the provider device network balancing system 100 can provide the locations of various provider devices in a geographic region and requestor device indicators. The provider device can provide this improved information while maintaining device security by hashing the identifiers of provider device identifiers, applying a minimum threshold of drivers required to display driver locations, limiting responses to send requests for provider device locations, limiting endpoint level requests, limiting device location queries to other devices within the same geographic region, and utilizing historical pickup location.

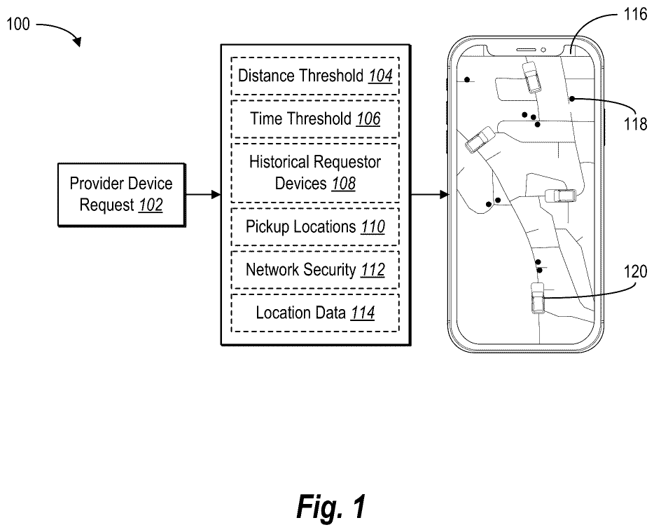

As just mentioned, in some implementations, the provider device network balancing system 100 provides an improved graphical user interface that includes requestor device indicators and provider device indicators. For example, FIG. 1 illustrates the provider device network balancing system 100 generating and providing a device network balance user interface in accordance with one or more embodiments.

As shown in FIG. 1, the provider device network balancing system 100 receives a provider device request 102. For example, the provider device network balancing system 100 receives the provider device request 102 from a provider device. As used herein, the term “provider device request” refers to a provider device sending a request to fetch data related to a device network balance user interface 116. Specifically, the provider device request 102 can cause a graphical user interface to provide provider device indicators and requestor device indicators (e.g., for a provider device to more accurately position themselves according to the balance of requestors and providers in a geographic region provided in a transparent manner). In some embodiments, the provider device automatically sends the provider device request 102 in response to accessing a transportation matching application. In some embodiments, the provider device selects an option to send the provider device request 102.

As used herein, the term “driver,” “provider” or “provider device” refers to a computing device associated with a transportation vehicle. For example, a provider device includes a user account associated with a computing device that can accept transportation requests and proceed to pick up a requestor associated with a requestor device. Specifically, the provider device can include a driver of a provider device that drives a vehicle to pick up a requestor device. In some embodiments, a provider device can include a device that corresponds to an autonomous vehicle (e.g., an AV vehicle) and the provider device can dispatch an autonomous vehicle to a location of a requestor device.

As used herein, the terms “user,” “rider,” “requestor” or “requestor device” refers to an individual that utilizes a client device to travel on a transportation vehicle associated with a provider device. For instance, a requestor device provides input to the client device to submits a transportation request to the provider device network balancing system 100 for a transportation match with a provider device.

Relatedly, the term “client device” refers to a computing device associated with (or utilized by) a user. In some implementations, a client device includes a client application having instructions that (upon execution) cause the client device to perform various actions for a disclosed system, as described herein. Such instructions may likewise cause a client device to present a graphical user interface that includes transportation-related information, submitting transportation requests, viewing transportation requests, accepting transportation requests, and viewing additional data related to the device network balance for one or more geographic regions.

As used herein, the term “transportation request” (or simply “request”) refers to a digital submission, invitation, or request for transportation services. A transportation request can include a collection of data sent to a transportation matching system comprising information associated with a transportation service sought by a requestor (e.g., pick-up location, drop-off location, transportation mode) as well as the desired transportation mode (e.g., via a public transit vehicle, private ride, shared ride, bike, scooter, bicycle, boat, etc.). In response to a transportation request from a requestor device, the provider device network balancing system 100 can match the request to one or more provider devices to fulfill the request.

As shown in FIG. 1, in response to the provider device request 102, the provider device network balancing system 100 extracts various data packets related to requestor devices and provider devices in a geographic region. For example, FIG. 1 shows the provider device network balancing system 100 determining a distance threshold 104. As used herein, the term “distance threshold” refers to a particular distance (or time corresponding to a distance). For example, a distance threshold can include a distance for delineating an area of a geographic region to display provider device indicators. Specifically, the provider device network balancing system 100 determines the provider device locations and uses the provider device locations to generate provider device indicators. For instance, the provider device network balancing system 100 can identify the distance threshold 104 based on a user interaction with a distance threshold selection element or a target number of provider devices to display. Moreover, the provider device network balancing system 100 causes the device network balance user interface 116 to display the provider device indicators based on the locations of the provider devices falling within the distance threshold.

As further shown, the provider device network balancing system 100 can determine a time threshold 106. As used herein, the term “time threshold” refers to a period of time (e.g., for generating requestor device indicators). In particular, a time threshold includes a period of time utilized to select a number or subset of requestor device indicators to surface. Specifically, the provider device network balancing system 100 can reference the time threshold 106 to determine which requestor device indicators to display on the device network balance user interface 116. For instance, the provider device network balancing system 100 identifies the pickup locations for historical requestor devices within the time threshold 106 (e.g., within the past 5 minutes, 10 minutes, 1 hour, 1 day) and causes the device network balance user interface 116 to show the requestor device indicators corresponding to the pickup locations.

As shown, the provider device network balancing system 100 can determine historical requestor devices 108. As used herein, the term “historical requestor devices” refers to requestor devices that have been picked up by provider devices (e.g., within the time threshold 106). Specifically, the historical requestor devices 108 refers to past requestor devices and corresponding pickup locations where the past requestor devices were transported by provider devices.

Further, FIG. 1 shows that the provider device network balancing system 100 can determine pickup locations 110. As used herein, the term “pickup location” refers to a place, position, or locality for picking up a requestor device. Specifically, a pickup location indicates where a provider device navigates for picking up a requestor device. In some embodiments, the pickup location includes where the request was sent from the requestor device. In some embodiments, the pickup location includes the actual location of where the provider device picked up the requestor device for transportation.

Moreover, FIG. 1 shows that the provider device network balancing system 100 can determine location data 114. For example, the location data 114 includes requestor device locations and provider device locations. As used herein, the term “requestor device location” refers to a geographic position of a computing device that is making a request to the transportation matching system. Specifically, the requestor device location can include a latitude, longitude, and altitude of a requestor device. Furthermore, the provider device network balancing system 100 can utilize a global positioning system (GPS) to identify the position of the requestor device. In some embodiments, the provider device network balancing system 100 can use Wi-Fi positioning or cell tower triangulation to determine the requestor device location.

As used herein, the term “provider device location” refers to a geographic position of a provider device. For instance, the provider device network balancing system 100 can track/detect real-time data associated with provider devices to determine where the provider devices are. Specifically, the provider device network balancing system 100 can update the interactive map to display the various locations of provider devices. In some embodiments, the provider device network balancing system 100 uses GPS, Wi-Fi location, or cell tower triangulation to determine the locations of the provider devices.

As also shown, the provider device network balancing system 100 can also apply procedures for network security 112 prior to displaying the device network balance user interface 116. For instance, the provider device network balancing system 100 can implement a variety of features to improve security for provider devices and requestor devices, including: (1) a minimum threshold of drivers required to display provider device locations, (2) hashing provider device identifiers to make provider devices untrackable, (3) limiting responses to send requests for provider device locations (to prohibit efforts to track provider devices over time); (4) limiting endpoint level requests for a particular time duration; (5) limiting device location queries to other devices within the same geographic region; or (6) utilizing historical pickup locations (so that others cannot view a current rider location).

As shown, the provider device network balancing system 100 provides the device network balance user interface 116 for display. Specifically, the device network balance user interface 116 includes requestor device indicators 118 and provider device indicators 120. As used herein, the term “requestor device indicator” refers to an element that represents requestor devices. Specifically, the provider device network balancing system 100 can determine requestor device locations and further identify pickup locations for the requestor devices transported by provider devices. From determining the pickup locations of requestor devices transported by provider devices, the provider device network balancing system 100 can further generate the requestor device indicators 118. For instance, the provider device network balancing system 100 can cause the device network balance user interface 116 to show the requestor device indicators 118 for a provider device to determine ‘recent’ data related to actual pickups. In some embodiments, the requestor device indicators 118 can include an indication of pending transportation requests. In other words, the requestor device indicators 118 can include data of not yet completed transportation requests (e.g., the provider device has not yet picked up a requestor device). In some embodiments, the provider device network balancing system 100 shows a number of pending transportation requests for a specific geographic region without showing the actual locations of the pending requests (e.g., as a security measure for preventing a bad actor from singling out a location of a pending request).

As used herein, the term “provider device indicators” refers to an element that represents provider devices. Specifically, the provider device network balancing system 100 can determine provider device locations. Moreover, the provider device network balancing system 100 can identify a distance threshold for a geographic region for the provider device and show provider devices in the device network balance user interface 116 based on the locations of the provider devices. For instance, the provider device network balancing system 100 displays the provider device indicators 120 to a provider device to help the provider device determine a volume of provider devices in a specific area.

As used herein, the term “device network balance user interface” refers to a graphical user interface of a provider device that indicates provider device data and requestor device data. Specifically, the device network balance user interface 116 refers to the provider device network balancing system 100 providing balance indicators in a graphical user interface. In other words, the provider device network balancing system 100 provides balance elements that show how balanced or imbalanced a particular geographic region is. As an example, the provider device network balancing system 100 can determine locations of requestor devices and provider devices and then cause a graphical user interface to show data related to the location of the requestor and provider devices. For instance, the provider device network balancing system 100 can cause the device network balance user interface 116 to show current provider devices (e.g., in a geographic location) and recent pickup events (e.g., requestor devices picked up by provider devices).

In one or more embodiments, the provider device network balancing system 100 can further cause the device network balance user interface 116 to display additional data to inform a provider device regarding supply, wait-times, types of provider pickup modes, and vehicle types. Thus, the provider device network balancing system 100 provides to a provider device a granular level of detail (in a transparent manner) to accurately and efficiently inform relocation decisions.

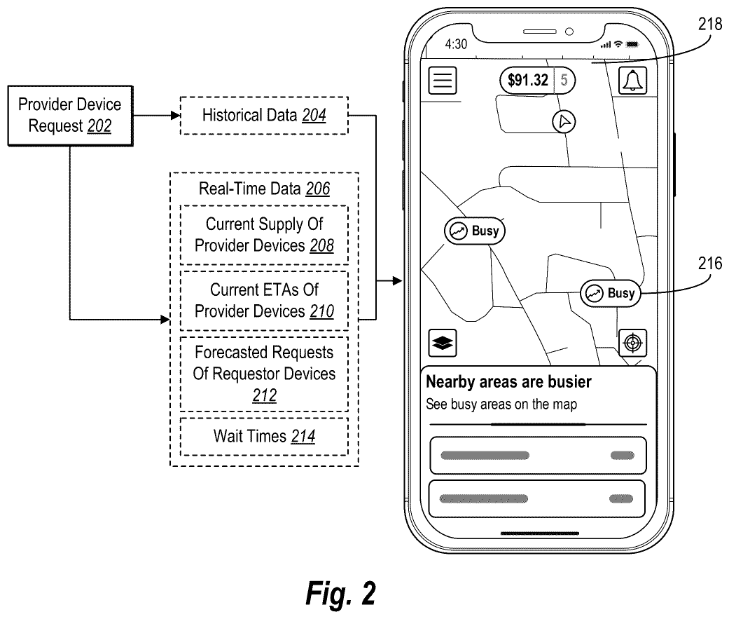

As mentioned above, the provider device network balancing system 100 determines device network balance selectable elements to recommend macro-positioning for provider devices. FIG. 2 illustrates the provider device network balancing system 100 utilizing historical data and real-time data to determine a plurality of device network balance selectable elements in accordance with one or more embodiments.

As shown in FIG. 2, the provider device network balancing system 100 provides device network balance selectable elements in a graphical user interface of a provider device to guide a provider device for macro-positioning. As used herein, the term “device network balance selectable element” refers to an element in a graphical user interface that indicates high-level representations of balance data within a transportation matching system. Specifically, a device network balance selectable element 216 (e.g., a busy pin, a zone, a fog zone indicating an area encompassing a busy region) refers to a high-level indicator (e.g., macro-positioning indicator) that a provider device can reference to determine where to relocate. For instance, the device network balance selectable element 216 can include indicators such as “high demand” (relative to a number of provider devices), “medium demand,” and “low demand.” In other words, the provider device network balancing system 100 uses the device network balance selectable element 216 as a broad recommendation for a provider to position themselves in a geographic area (e.g., to optimize their transportation matches). In some embodiments, the provider device network balancing system 100 determines the device network balance selectable elements 216 from real-time data 206 and historical data 204.

As shown in FIG. 2, the provider device network balancing system 100 receives a provider device request 202 from a provider device. As mentioned above, the provider device request 202 includes a data request to fetch data related to a network balance in a transportation matching environment. As shown, in response to the provider device request 202, the provider device network balancing system 100 leverages historical data 204 and real-time data 206 to determine the device network balance selectable element 216. As used herein, the term “historical data” refers to previous balance data of the transportation matching system. Specifically, the provider device network balancing system 100 store prior data related to requests, pickups, driver locations, and additional metrics related to the balance of various geographic regions over time. In some embodiments, the provider device network balancing system 100 uses computer-implemented algorithms, such as machine learning models, to process the historical data 204 and generate predictions for geographic regions.

Moreover, in addition to drawing from the historical data 204, the provider device network balancing system 100 can also draw from the real-time data 206. As used herein, the term “real-time data” refers to concurrent balance data of a transportation matching system.

Specifically, the provider device network balancing system 100 consistently receives transportation requests and provider device data and stores the data within a database. In some embodiments, the provider device network balancing system 100 updates the database in real-time or in near real-time. Moreover, the real-time data 206 can include current supply of provider/requestor devices 208, current estimated time of arrivals of provider devices 210 (ETAs), forecasted requests of requestor devices 212, and wait-times 214.

As indicated in FIG. 2 (by the dotted lines), the provider device network balancing system 100 can use either one of the historical data 204 and/or the real-time data 206 to determine the network balance data for a transportation matching system. In some embodiments, the provider device network balancing system 100 initially only leverages the real-time data 206 to provide the provider device with a snapshot of what is currently occurring. Further, in some embodiments, the provider device network balancing system 100 can provide an option to the provider device (e.g., who submitted the provider device request 202) for the provider device network balancing system 100 to further provide the device network balance selectable element 216 based on the historical data 204. In some embodiments, the provider device network balancing system 100 initially determines the device network balance selectable element 216 based on the historical data 204 and further provides an option to the provider device for the provider device network balancing system 100 to further provide the device network balance selectable element 216 based on the real-time data 206.

Moreover, in some embodiments, the provider device network balancing system 100 can provide an option for the provider device to indicate to the provider device network balancing system 100 to use one or more of the historical data 204 and/or the real-time data 206 (e.g., prior to submitting the provider device request 202) when generating the device network balance selectable element 216.

As shown, the provider device network balancing system 100 generates a device network balance user interface 218 that includes an interactive map based on the historical data 204 and the real-time data 206. As used herein, the term “interactive map” refers to a digital map that allows a provider device to engage with various features. Specifically, the interactive map of a geographic region allows a provider device to determine macro-positioning (e.g., how to position the provider device relative to other geographic regions) and also to determine micro-positioning (e.g., how to position the provider device within a specific geographic region). For instance, the provider device network balancing system 100 provides the interactive map to a provider device, and the provider device can interact with one or more features (e.g., zoom-in, zoom-out, click a specific region, change layers or features to display) to view more granular details or to view more high-level information.

As shown in FIG. 2, based on the historical data 204 and the real-time data 206, the provider device network balancing system 100 generates the device network balance user interface 218 that includes the device network balance selectable elements 216. Specifically, the device network balance selectable elements 216 show “busy” indicators. For instance, the busy indicators inform the provider device of an imbalance of requestor devices and provider devices in a specific region. By providing this indication to the provider device, the provider device network balancing system 100 induces improved macro-repositioning by provider devices.

In some embodiments, the provider device network balancing system 100 provides an indication to the provider device that they are already in a “busy zone” and thus the provider device does not need to relocate. Specifically, if the provider device is within a predefined minute driving radius of a busy area (e.g., a geographic region with an imbalance of provider devices relative to requestor devices) then the provider device network balancing system 100 notifies the provider device that they are already in an optimal region. Additionally, in response to the provider device already being in an optimal region, the provider device network balancing system 100 can further provide transparent micro-positioning details to the provider device.

In one or more embodiments, based on a selection of the device network balance selectable elements 216, the provider device network balancing system 100 can cause the graphical user interface to display options to further provide wait times, nearby provider devices, recent pickup events, and/or additional filters related to the selected the device network balance selectable elements 216.

In one or more embodiments, the provider device network balancing system 100 optimizes a network balance within the transportation matching system by sending provider devices to an airport. For example, the device network balance selectable elements 216 can include indications for the provider device to relocate to a nearby airport. Specifically, based on the historical data 204 and the real-time data 206, the provider device network balancing system 100 determines that the nearby airport includes an imbalance, and the provider device network balancing system 100 provides the provider device indicators and the requestor device indicators to the provider device to see the imbalance (e.g., a level of imbalance at the airport, such as busy or very busy). Furthermore, in some embodiments, the provider device network balancing system 100 can further add an incentive (e.g., a bonus) for the provider device to relocate to one of the “busy” areas as indicated by the device network balance selectable elements 216. Unlike conventional systems, the provider device network balancing system 100 provides context for why a provider should relocate to another geographic region (e.g., such as the airport). In other words, the provider device network balancing system 100 provides supporting contextual evidence for both macro and micro positioning within a “busy” geographic region. Thus, the transparent granular details provided by the provider device network balancing system 100 allows for more optimal (e.g., accurate and efficient) positioning of provider devices across and within geographic regions.

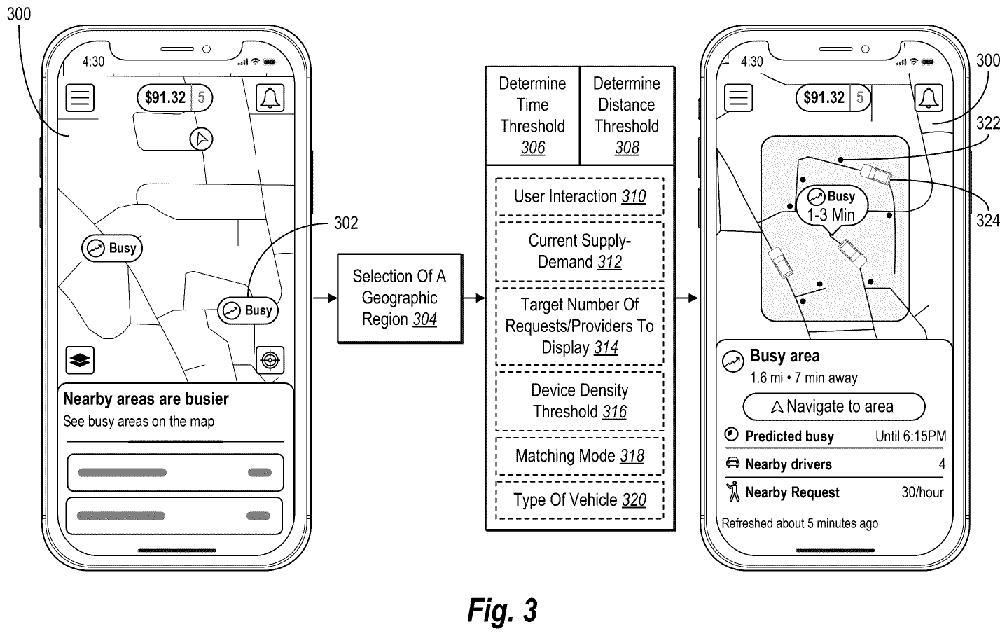

As mentioned above, the provider device network balancing system 100 can further hone in on granular details of a geographic region in response to a selection of a device network balance selectable element. FIG. 3 illustrates the provider device network balancing system 100 utilizing a time threshold and a distance threshold to determine requestor device indicators and provider device indicators in accordance with one or more embodiments.

As shown in FIG. 3, the provider device network balancing system 100 receives a selection 304 of a geographic region. Specifically, the provider device network balancing system 100 can receive the selection 304 of a device network balance selectable element 302 (e.g., the device network balance selectable element 216 discussed above in FIG. 2). In response to the selection of the device network balance selectable element 302, the provider device network balancing system 100 can determine a time threshold 306 and a distance threshold 308. In other words, the provider device network balancing system 100 receives a selection of a high-level indicator (e.g., for macro-positioning), and in response, draws upon more granular data to provide micro-positioning data to the provider device.

In some embodiments, the provider device network balancing system 100 can dynamically select the time threshold 306 and/or the distance threshold 308 utilized in surfacing nearby provider devices and/or recent ride pickup events (e.g., based on user interaction and/or the number of rides in the region). Similarly, the provider device network balancing system 100 can filter nearby provider devices based on certain factors (e.g., such as provider devices having a matching mode or vehicle type). In some implementations, the provider device network balancing system 100 allows provider devices to control the type of information shown within the device network balance user interface (e.g., recent rides, drivers, wait time, certain driver modes, types of rides, etc.).

For example, in some implementations, the provider device network balancing system 100 selects the time threshold 306 to satisfy a target number 314 of requestor devices. Specifically, the provider device network balancing system 100 selects the target number 314 of requestor devices (e.g., 10) and then increases the time threshold 306 (e.g., 5 minutes, 10 minutes, 1 hour) until identifying a historical number of ride pickup events that satisfies the target number of requestor devices (e.g., 10 pickup events within the past hour). In other words, the provider device network balancing system 100 pre-establishes a number of requestor devices to show in a device network balance user interface 300 and incrementally moves back in time until the pre-established number of requestor devices can be shown in the device network balance user interface 300.

Similarly, in some implementations, the provider device network balancing system 100 selects the distance threshold 308 to satisfy the target number 314 of provider devices. Specifically, the provider device network balancing system 100 selects the target number 314 of provider devices (e.g., 10) and then increases the distance threshold 308 (e.g., 0.25 miles, 1 mile, 5 miles) until identifying provider devices within the distance threshold 308 that satisfy the target number of provider devices (e.g., 10 additional provider devices within a 5-mile radius of the current provider device).

As shown in FIG. 3, the provider device network balancing system 100 determines the time threshold 306 and the distance threshold 308 based on a geographic region. Specifically, as shown, based on a selection of the device network balance selectable element 302, the provider device network balancing system 100 determines a specific geographic region and using the specific geographic region, the provider device network balancing system 100 further determines the time threshold 306 and the distance threshold 308. As used herein, the term “geographic region” refers to a specific location or region corresponding to a device network balance selectable element (e.g., busy, low demand, high demand, medium demand). Specifically, a geographic region refers to an area or zone encompassed by the interactive map. For instance, the provider device network balancing system 100 can show the requestor device indicators and the provider device indicators for a geographic region.

As further shown in FIG. 3, the provider device network balancing system 100 can determine the time threshold 306 and the distance threshold 308 based on a user interaction 310, a current supply-demand 312, a target number of requests/providers to display 314, a device density threshold 316, a matching mode 318, and/or a type of vehicle 320.

As shown, the provider device network balancing system 100 can determine the time threshold 306 and the distance threshold 308 based on the user interaction 310. In some embodiments, the provider device network balancing system 100 provides a time threshold selection element for a provider device to indicate the time threshold 306. As used herein, the term “time threshold selection element” refers to a user interaction element within the device network balance user interface 300. Specifically, the device network balance user interface 300 includes an element to select for different time thresholds (e.g., 5 minutes, 10 minutes, 1 hour, etc.). In response to a selection from a provider device, the provider device network balancing system 100 causes the device network balance user interface 300 to display the requestor device indicators within the selected time threshold. For instance, the provider device network balancing system 100 provides an option menu (that includes the time threshold selection element) for the provider device in the device network balance user interface 300 to select from, and in response to a selection, the provider device network balancing system 100 updates the device network balance user interface 300.

In some embodiments, the provider device network balancing system 100 provides a distance threshold selection element for a provider device to indicate the distance threshold 308 (e.g., in an option menu provided for display in the device network balance user interface 300). As used herein, the term “distance threshold selection element” refers to a user interaction element within the device network balance user interface 300. Specifically, the device network balance user interface 300 includes an element to select for different distances (e.g., 25-mile radius, 10 miles radius, 5 mile radius, etc.). In response to a selection from a provider device, the provider device network balancing system 100 causes the device network balance user interface 300 to display the provider indicators within the selected distance threshold.

In some embodiments, the provider device network balancing system 100 can determine the time threshold and/or the distance threshold 308 based on the current supply-demand 312. As used herein, the term “current supply-demand” refers to a balance of requestor devices and provider devices in a selected geographic region (e.g., a network balance of requestor devices and provider devices). Specifically, the current supply-demand includes a calculation based on a number of requests sent across a computer network from requestor devices and a number of available provider devices to accept the requests (e.g., on the computer network).

In some embodiments, the provider device network balancing system 100 determines the time threshold 306 and/or the distance threshold 308 based on a target number of devices. As used herein, the term “target number of requestor devices” refers to a minimum number of requestor device indicators to display within the device network balance user interface 300. Specifically, the provider device network balancing system 100 uses the target number of requestor devices to determine a time or distance for filtering devices to surface within the device network balance user interface 116. For instance, if the target number of requestor devices is twenty requestor device indicators, the provider device network balancing system 100 selects a time and/or distance (and corresponding zoom level) of the geographic region that satisfies the target number. In other words, the provider device network balancing system 100 can incrementally adjust the time (e.g., 5 minutes, 10 minutes, 15 minutes) and the corresponding zoom level (e.g. 1 mile radius, 5 mile radius, 10 mile radius) until an optimal number of requestor devices is shown in the device network balance user interface 300).

As used herein, the term “target number of provider devices” refers to a minimum number of provider device indicators to display within the device network balance user interface 300. Specifically, the provider device network balancing system 100 uses the target number of provider devices to determine time or distance for filtering provider devices within the device network balance user interface 300. For instance, if the target number of provider devices is five provider device indicators, the provider device network balancing system 100 selects a distance within the geographic region that satisfies the target number.

In some embodiments, the provider device network balancing system 100 determines the time threshold 306 and/or the distance threshold 308 based on the device density threshold 316. As used herein, the term “device density threshold” refers to a number of indicators in the device network balance user interface 300. In contrast to the target number of provider devices and the target number of requestor devices, the device density threshold 316 refers to an aggregate of the indicators shown in the device network balance user interface 300. For instance, the device density threshold 316 can be a threshold of at least fifteen indicators. Accordingly, the provider device network balancing system 100 can select the time threshold 306 and/or the distance threshold 308 (and corresponding zoom level) that satisfies the device density threshold 316. In other words, the provider device network balancing system 100 bases the device density threshold 316 based on both the number of provider device indicators and the requestor device indicators.

In some embodiments, the provider device network balancing system 100 determines the matching mode 318 for the provider device corresponding to the device network balance user interface 300. Specifically, the provider device network balancing system 100 can determine that the matching mode 318 for the provider device is for a green vehicle, a priority pickup, a luxury vehicle (e.g., premium, extra comfort, etc.), extra seats, and wheel-chair accessible. Based on the matching mode 318, the provider device network balancing system 100 can further determine the time threshold 306 and the distance threshold 308. To illustrate, the provider device network balancing system 100 can determine time or distance for the geographic region shown in the device network balance user interface 300 to only show provider devices that have the same matching mode as the provider device. By providing this option, the provider device network balancing system 100 allows the provider device to have access to relevant data for their specific type of matching mode. In other words, the provider device can access accurate and relevant information (at a granular level of detail) for their type of matching and not be inundated with irrelevant information (e.g., provider devices that do not perform their same type of service).

Moreover, in some embodiments, the provider device network balancing system 100 can determine the type of vehicle 320 for the provider device corresponding to the device network balance user interface 300. For instance, the provider device network balancing system 100 can determine that the provider device drives a sedan, a truck, an SUV, or a van. Based on the type of vehicle 320, the provider device network balancing system 100 can further determine the time threshold 306 and the distance threshold 308. To illustrate, the provider device network balancing system 100 can determine a target number of provider devices to display on the device network balance user interface 300 (e.g., at least ten provider devices) and further determine a correspondence between the target number of provider devices and the type of vehicle 320. For instance, if the provider device network balancing system 100 determines the type of vehicle 320 as a van, the provider device network balancing system 100 then determines the distance threshold 308 for the van type that satisfies a target number of provider devices. In some embodiments, the provider device network balancing system 100 utilizes the type of vehicle 320 to determine the time threshold 306. For instance, the provider device network balancing system 100 determines a correspondence between the type of vehicle 320 and a target number of pickup events to display on the device network balance user interface 300. To illustrate, if the type of vehicle 320 is a truck, the provider device network balancing system 100 further determines the time threshold 306 for the truck that satisfies a target number of pickup events to show on the device network balance user interface 300.

As shown in FIG. 3, based on the provider device network balancing system 100 determining the time threshold 306 and the distance threshold 308, the provider device network balancing system 100 can further generate and provide for display the device network balance user interface 300. Specifically, FIG. 3 shows the device network balance user interface 300 with requestor device indicators 322 and provider device indicators 324. For instance, FIG. 3 shows the device network balance user interface 300 with three other provider devices in the specific geographic region and a handful of pickup events that also occurred in the specific geographic region.

In one or more embodiments, the provider device network balancing system 100 causes the device network balance user interface 300 to update on a consistent basis to show in real-time or in near real-time movement of the provider device indicators 324 and additional requestor device indicators (e.g., additional pickup events). For instance, the provider device network balancing system 100 can fetch additional data every five seconds (or ten seconds or three seconds) to update the device network balance user interface 300.

Additionally, as shown in FIG. 3, the provider device network balancing system 100 can further cause the device network balance user interface 300 to show further information indicating additional geographic regions that the provider device could relocate to. Specifically, FIG. 3 shows another “busy area” that is 1.6 miles away from the provider device, with a projection of how long the area will stay “busy” (e.g., until 6:15 p.m.), the nearby drivers and the nearby requests. Moreover, FIG. 3 shows the provider device network balancing system 100 indicating how long ago the device network balance user interface 300 was updated (e.g., refreshed about 5 minutes ago).

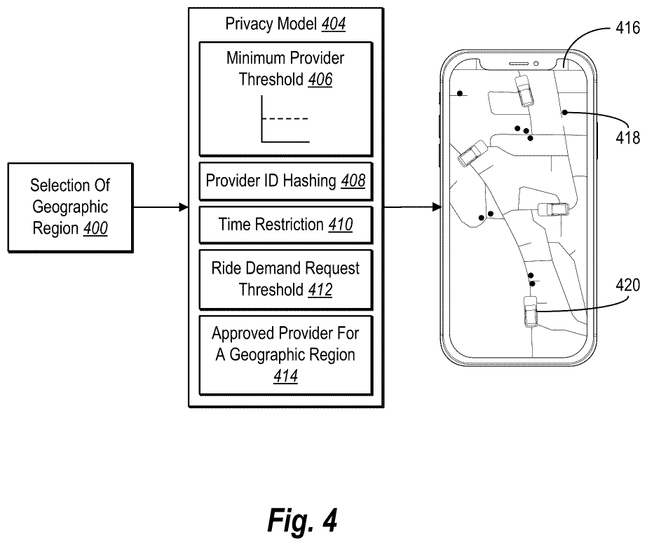

As mentioned above, the provider device network balancing system 100 can perform a variety of security measures to protect the privacy and security of client devices. FIG. 4 illustrates the provider device network balancing system 100 receiving a selection (e.g., of a geographic region in a user interface of a provider device) and utilizing a privacy model to generate the device network balance user interface in accordance with one or more embodiments. For example, FIG. 4 shows the provider device network balancing system 100 receiving a selection 400 of the geographic region and utilizing a privacy model 404 to determine a minimum provider threshold 406, perform provider ID hashing 408, determine a time restriction 410, determine a ride demand request threshold 412, and/or determine whether a provider device is an approved provider for a geographic region.

In one or more embodiments, the provider device network balancing system 100 determines a minimum provider threshold 406. Specifically, the minimum provider threshold 406 can indicate that there needs to be at least five provider devices for the provider device network balancing system 100 to display provider devices on the device network balance user interface. In using the minimum provider threshold 406, the provider device network balancing system 100 prevents a provider device from tracking a single provider device. For instance, the provider device network balancing system 100 receives the selection 400 of the geographic region and determines a current number of provider devices in the selected region. Further, the provider device network balancing system 100 compares the current number of provider devices with the minimum provider threshold 406 to determine whether the minimum provider threshold 406 is satisfied.

In one or more embodiments, the provider device network balancing system 100 hashes driver identifiers when displaying the provider device indicators on the device network balance user interface. Specifically, the provider device network balancing system 100 converts an identifier associated with a provider device (e.g., a username, an email address, or other piece of identifying data associated with a provider device). For instance, the provider device network balancing system 100 hashes the identifier by converting the piece of data into a fixed-size string of characters using a hash function. In one or more embodiments, the provider device network balancing system 100 uses a hashing function, which is a one-way function that makes the original data very difficult to retrieve from the hashed value.

As used herein, the term “provider device queries” refers to a request from the provider device to access, identify, and/or display information regarding a provider device (e.g., the provider device indicators). For instance, the provider device network balancing system 100 can update the device network balance user interface every few seconds to fetch the provider device locations of provider devices in the geographic region. Specifically, if the provider device has the device network balance user interface up for one minute, the provider device network balancing system 100 may fetch the provider device data for that geographic region multiple times.

In doing so, the provider device network balancing system 100 receives multiple queries from the provider device to show an updated device network balance user interface. In one or more embodiments, the provider device network balancing system 100 can withhold responses to update the device network balance user interface. In other words, the provider device network balancing system 100 can prevent bad actors from tracking the location of provider devices in a geographic region. For instance, the provider device network balancing system 100 can establish a threshold number of times (e.g., the time restriction 410) a provider device can query the provider device network balancing system 100 to update the device network balance user interface. After the threshold number of times is met, the provider device network balancing system 100 can withhold responses.

Moreover, in some embodiments, the provider device network balancing system 100 determines the ride demand request threshold 412. Specifically, the ride demand request threshold 412 can limit endpoint level requests for a particular time duration. For instance, the provider device network balancing system 100 determines that a provider device has been parsing a specific geographic location (e.g., fetching ride demand data requests) an excessive number of times (e.g., surpassing a threshold number of ride demand data requests) and the provider device network balancing system 100 prohibits the particular provider device from querying the endpoint to obtain the ride demand data for a threshold period of time (e.g., the rest of the day).

In one or more embodiments, the provider device network balancing system 100 can further implement a digital privacy policy to show a minimum of at least ten pickup events in the device network balance user interface 416. In using a minimum number of pickup events policy, the provider device network balancing system 100 can prevent a provider device from singling out a pickup event (e.g., by only showing pickup events on the device network balance user interface 416 when there are at least ten pickup events).

In one or more embodiments, the provider device network balancing system 100 determines whether a provider device is an approved provider 414 for a geographic region. Specifically, the provider device network balancing system 100 can compare an identifier of the provider device corresponding to the device network balance user interface with a list of identifiers approved to receive transportation requests for the geographic region. If the provider device is not the approved provider 414 for the geographic region, the provider device network balancing system 100 can withhold showing provider device indicators and requestor device indicators in the device network balance user interface. In some implementations, the provider device network balancing system 100 approves provider devices that are within a particular proximity of a geographic region (e.g., within the region or within a certain threshold distance/time of the region).

As shown in FIG. 4, based on the provider device network balancing system 100 utilizing the privacy model 404, the provider device network balancing system 100 can further generate a device network balance user interface 416 that displays requestor device indicators 418 and provider device indicators 420. Specifically, the provider device network balancing system 100 provides the device network balance user interface 416 based on the various privacy policies of the privacy model 404 being fulfilled. In one or more embodiments, the provider device network balancing system 100 utilizes various combinations of the minimum provider threshold 406, the provider ID hashing 408, the time restriction 410, the ride demand request threshold 412, and/or the approved provider 414 for a geographic region to generate the device network balance user interface 416.

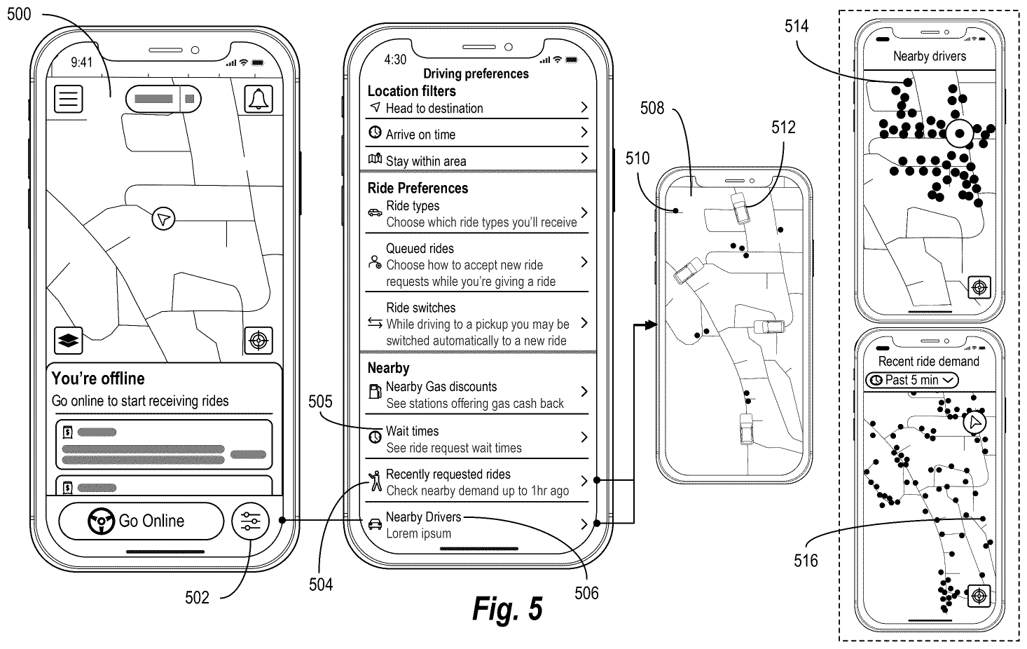

FIG. 5 illustrates additional graphical user interfaces of the device network balance user interface. As shown in FIG. 5, the provider device network balancing system 100 can provide a graphical user interface 500 to a provider device prior to going online (or at another time, such as after going online). For instance, the graphical user interface 500 can provide an option 502 to filter an interactive map. As shown, in response to a selection of a filter, the provider device network balancing system 100 provides a graphical user interface with a plurality of filtering elements.

In one or more embodiments, the provider device network balancing system 100 can provide a dynamic map with regions classified based on supply-demand balance. This can provide more general region-positioning recommendations for drivers (e.g., in addition to particular locations of demand or drivers within a region). To illustrate, in some implementations, the provider device network balancing system 100 provides a map with supply-demand balance elements (e.g., with an indicator for how long the supply-demand balance will persist and/or estimated wait times within the region). Based on selection of one of these elements, the provider device network balancing system 100 surfaces elements that show more specifics regarding ride demand (e.g., previous transportation requests) and/or drivers (e.g., location of drivers) on the map

For example, FIG. 5 shows a filter 504 for recently requested rides and for nearby drivers. In response to a selection of the filter 504 for recently requested rides, the provider device network balancing system 100 can generate the provider device network balance user interface that shows the recent pickup events (e.g., requestor devices picked up by provider devices). Additionally, FIG. 5 shows that in response to a selection of a nearby drivers filter 506, the provider device network balancing system 100 can generate a graphical user interface of nearby provider devices. Specifically, FIG. 5 shows the provider device network balancing system 100 providing for display a device network balance user interface 508 that includes provider device indicators 512 and requestor device indicators 510. In some embodiments, the provider device network balancing system 100 allows the provider device to select both the filter 504 and the nearby drivers filter 506 (e.g., select multiple filters). In some embodiments, the provider device network balancing system 100 provides the filter 504 and the nearby drivers filter 506 as a single filter and in response to a selection of the single filter, the provider device network balancing system 100 generates the device network balance user interface 508.

Furthermore, as shown in FIG. 5, the provider device network balancing system 100 can just show provider device indicators 514 in response to a selection of just the nearby drivers filter 506. Moreover, as also shown, the provider device network balancing system 100 can just show requestor device indicators 516 in response to a selection of just the filter 504. Additionally, in some embodiments, the provider device network balancing system 100 can further receive a selection of a wait times filter 505 or another filter and layer on the additional data on top of the already selected filters. For instance, FIG. 5 shows the device network balance user interface 508 that displays both the provider device indicators 512 and the requestor device indicators 510. Moreover, in response to the wait times filter 505, the provider device network balancing system 100 further adds wait time indicators to the device network balance user interface 508.

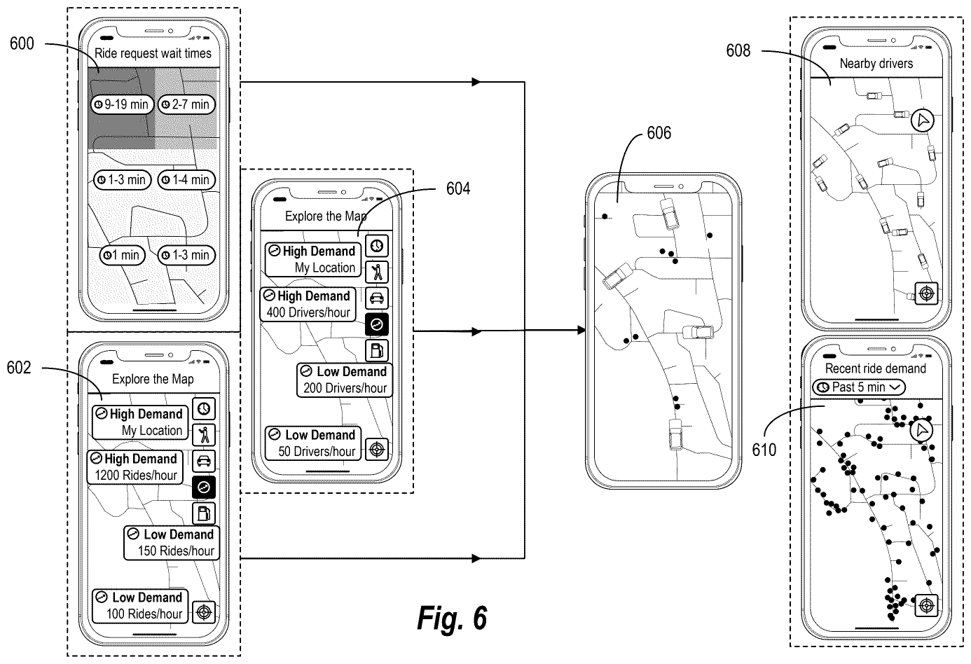

FIG. 6 illustrates different graphical user interfaces showing different device network balance selectable elements and transitioning to another graphical user interface in response to a selection of a device network balance selectable element.

As shown in FIG. 6, the provider device network balancing system 100 can provide a graphical user interface 600 with wait times for different regions, a graphical user interface 602 with high-level balance indicators indicating the number of rides in an hour, and/or a graphical user interface 604 indicating the number of drivers in an hour. Specifically, the provider device network balancing system 100 can automatically determine to show one of the graphical user interfaces shown in FIG. 6 (or a combination of the information from two or more of the graphical user interfaces) or can receive a selection by the provider device indicating the type of graphical user interface to display.

Specifically, FIG. 6 illustrates the provider device network balancing system 100 providing to a provider device a high-level macro-positioning interface to guide the provider device to position themselves in an optimal geographic region. In response to a selection of an element in one or more of the high-level macro-positioning interfaces, the provider device network balancing system 100 provides more granular details. For instance, the graphical user interface 600 shows wait times (9-19 minutes, 2-7 minutes, etc.) to a provider device and the provider device can select one of the regions encompassed by the wait times (e.g., select the 1 minute wait time). In response to selecting the wait time region, the provider device network balancing system 100 generates a device network balance user interface 606. For example, the device network balance user interface 606 shows provider device indicators and requestor device indicators associated with the wait time region. As used herein, the term “wait-time filter” refers to the provider device network balancing system 100 filtering the device network balance user interface by estimated wait times (e.g., determined from historical data) or by actual wait times (e.g., determined from real-time data).

In some embodiments, the provider device network balancing system 100 shows the device network balance selectable elements (e.g., high demand, low demand, etc.) and in response to a selection of one of the device network balance selectable elements, the provider device network balancing system 100 generates the device network balance user interface 606. As shown in FIG. 6, the graphical user interface 602 shows the device network balance selectable elements with the current number of rides per hour (1200 rides/hour).

Additionally, in some embodiments, the provider device network balancing system 100 provides the graphical user interface 604 to a provider device. Specifically, the graphical user interface 604 includes device network balance selectable elements with the current number of drivers per hour (e.g., 200 drivers/hour). In response to a selection of one of the device network balance selectable elements, the provider device network balancing system 100 can generate the device network balance user interface 606. Moreover, FIG. 6 shows the provider device network balancing system 100 alternatively providing a user interface 608 of just the nearby provider devices or a user interface 610 of just the requestor device indicators (e.g., recent pickup events).

As mentioned above, the provider device network balancing system 100 can show a combination of the graphical user interfaces. Specifically, the provider device network balancing system 100 provides for display to a provider device a combination of the device network balance selectable elements with the wait times (e.g., graphical user interface 600 layered over graphical user interface 602).

In some embodiments, the provider device network balancing system 100 can provide a graphical user interface for forecasted network balances of multiple geographic regions. Specifically, the provider device network balancing system 100 can draw from historical data to determine the forecasted network balance. Further, the provider device network balancing system 100 can provide forecasted network balance elements in the user interface, and in response to a selection of a forecasted network balance element in the user interface, the provider device network balancing system 100 can further provide for display micro-positioning elements (e.g., provider device indicators and requestor device indicators).

In one or more embodiments, the provider device can select a high-level macro-positioning element in a graphical user interface, and in response, the provider device network balancing system 100 can provide options for micro-positioning elements. In some embodiments, the provider device network balancing system 100 can allow the provider device to select micro-positioning elements (e.g., filters) prior to selecting a high-level macro-positioning element. For instance, the provider device network balancing system 100 can provide micro-positioning filter elements such as a transportation matching mode filter and a vehicle type filter.

As used herein, the term “transportation matching mode filter” refers to the provider device network balancing system 100 filtering the device network balance user interface by a mode selected by a provider device. Specifically, the transportation matching mode can include luxury transportation matches, regular transportation matches, multi-rider transportation matches, etc. Thus, the provider device accessing the device network balance user interface can view the provider devices (e.g., provider device indicators) according to the type of transportation matches.

In one or more embodiments, the provider device network balancing system 100 can receive a selection of a filter from the provider device. As used herein, the term “vehicle type filter” refers to the provider device network balancing system 100 filtering the device network balance user interface by a type of vehicle. Specifically, the vehicle type filter includes filters such as sedan, over-sized vehicle, truck, etc. Thus, the provider device network balancing system 100 generates the device network balance user interface 606 that includes provider device indicators according to the selected transportation matching filter and/or the vehicle type filter.

Although not shown in FIGS. 5 and 6, in one or more embodiments, the provider device network balancing system 100 determines that there is insufficient data to surface in the device network balance user interface 606 after applying one or more filters (e.g., after applying the time threshold and/or the distance threshold). Specifically, in response to determining that the time threshold and the distance threshold filter out too many provider devices and/or requestor devices (so that a target number of provider devices cannot be reached), the provider device network balancing system 100 causes the device network balance user interface to display an insufficient data message. Furthermore, in some embodiments, the provider device network balancing system 100 can prompt the provider device to select another time and/or distance threshold.

FIGS. 1-6 discuss the provider device network balancing system 100 generating and providing for display the device network balance user interface to optimize positioning of provider devices. In some embodiments, the provider device network balancing system 100 can provide for display the device network balance user interface in response to a provider device opening a transportation matching application. Moreover, in some embodiments, the provider device network balancing system 100 can provide for display the device network balance user interface after a certain amount of time has passed in the transportation matching application without any ride requests. In other words, the provider device network balancing system 100 can prompt a provider device to relocate to a different geographic region (e.g., macro-positioning) in response to a lack of ride requests.

The components of the provider device network balancing system 100 can include software, hardware, or both. For example, the components of the provider device network balancing system 100 can include one or more instructions stored on a computer-readable storage medium and executable by processors of one or more computing devices. When executed by the one or more processors, the computer-executable instructions of the provider device network balancing system 100 can cause the computing device to perform the methods described herein. Alternatively, the components of the provider device network balancing system 100 can comprise hardware, such as a special purpose processing device to perform a certain function or group of functions. Additionally, or alternatively, the components of the provider device network balancing system 100 can include a combination of computer-executable instructions and hardware.

Furthermore, the components of the provider device network balancing system 100 performing the functions described herein may, for example, be implemented as part of a stand-alone application, as a module of an application, as a plug-in for applications including content management applications, as a library function or functions that may be called by other applications, and/or as a cloud-computing model. Thus, the components of the provider device network balancing system 100 may be implemented as part of a stand-alone application on a personal computing device or a mobile device. Alternatively, or additionally, the components of the provider device network balancing system 100 may be implemented in any application that generates and provides notifications, but not limited to, various applications.

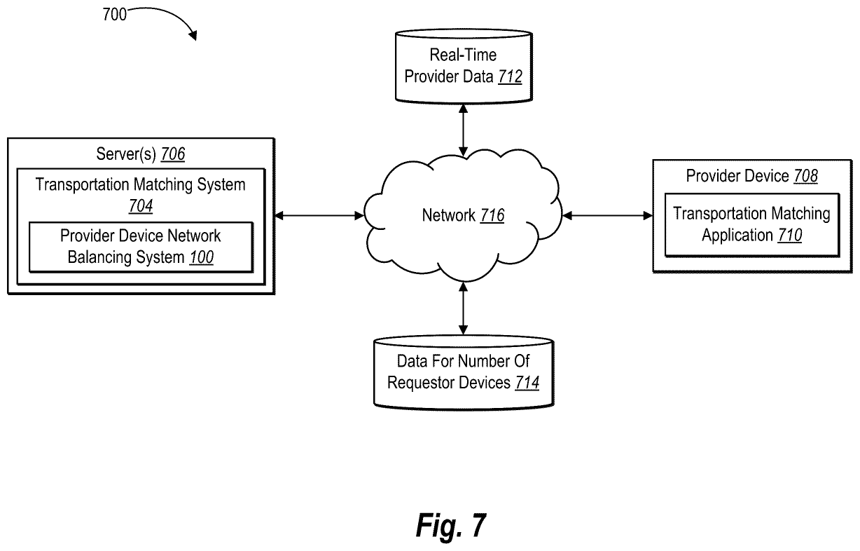

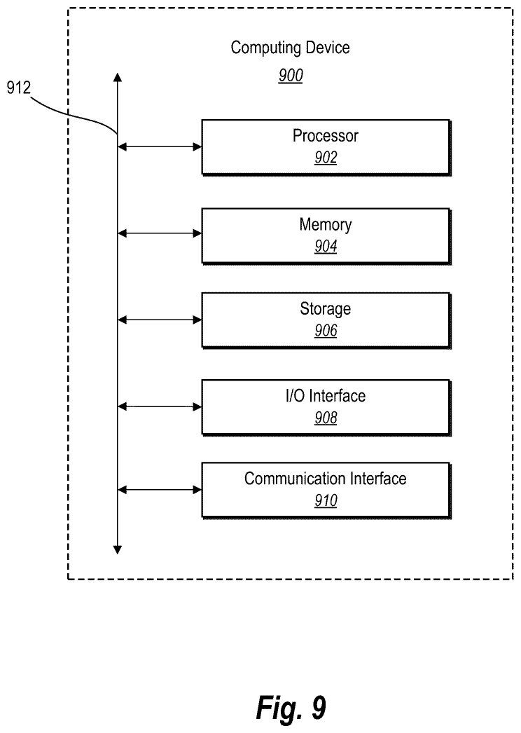

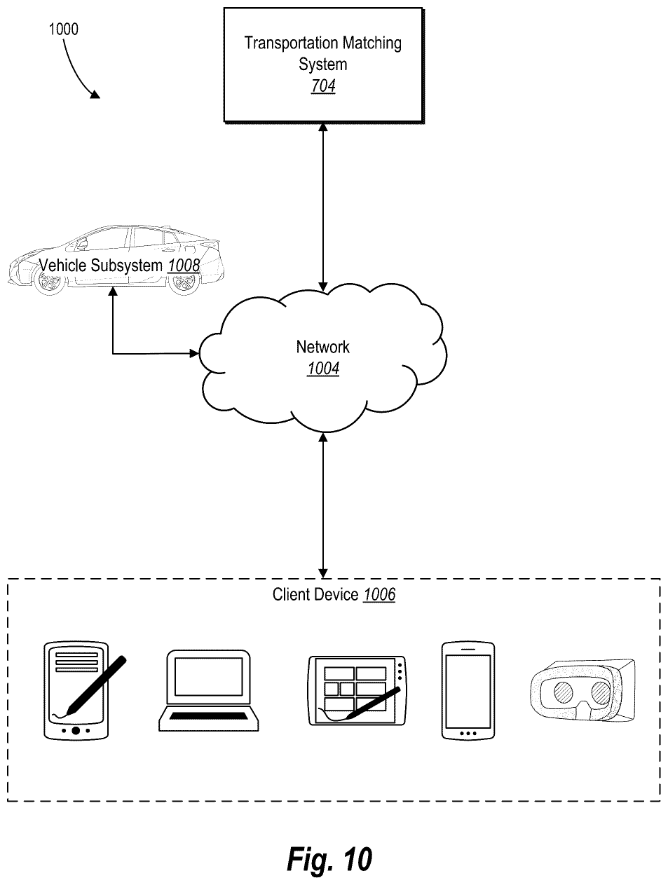

Additional detail regarding the digital notification system will now be provided with reference to the figures. In particular, FIG. 7 illustrates a block diagram of a system environment for implementing the provider device network balancing system 100 in accordance with one or more embodiments. As shown in FIG. 7, the environment includes server(s) 706 housing a transportation matching system 704. The environment of FIG. 1 further includes a provider device 708 (including a transportation matching application 710), a network 716, real-time provider data 712, and data for a number of requestor devices 714. Furthermore, in one or more embodiments, the provider device 708 includes an infotainment screen (e.g., built into a dashboard, a seat, a ceiling, or other surface of a vehicle). The server(s) 706 can include one or more computing devices to implement the provider device network balancing system 100. Additional detail regarding the illustrated computing devices (e.g., the server(s) 706 and the provider device 708) is provided with respect to FIGS. 9-10 below.

As shown, the provider device network balancing system 100 the network 716 to communicate with the provider device 708. The network 716 may comprise any network described in relation to FIGS. 9-10. For example, the provider device network balancing system 100 communicates with the provider device 708 to generate notifications and/or a device network balance user interface and provide for display the notifications on the provider device 708. Indeed, as already mentioned, the provider device network balancing system 100 can receive a provider device query to provide for display the device network balance user interface that displays the provider device indicators and the requestor device indicators.

Moreover, the provider device 708 can receive a transportation request from a requestor device and can provide requestor information to various provider device, such as a requested location (e.g., a requested pickup location and/or a requested drop-off location), a requestor identification, and a requested pickup time. In some embodiments, per device settings, the transportation matching system 704 or the provider device network balancing system 100 receives device information from various provider devices and various requestor devices, such as location, driving patterns, transportation matching telematics data, transportation matching schedules, a number of requests in a geographic location, transportation matching driver ratings, and transportation matching vehicle types.

Furthermore, the provider device network balancing system 100 can monitor the real-time provider data 712 to determine a plurality of provider device locations for a specific geographic region. Specifically, based on the real-time provider data 712, the provider device network balancing system 100 can generate the provider device indicators to provide for display the nearby provider devices via the transportation matching application 710. Additionally, the provider device network balancing system 100 can monitor the data for a number of requestor devices 714 to determine recent pickup events. Specifically, the provider device network balancing system 100 can determine requestor device locations and recent pickups of the requestor devices. Furthermore, the provider device network balancing system 100 can cause a graphical user interface of the provider device 708 to display the recent pickup events.

To facilitate providing notifications to client devices, in some embodiments, the provider device network balancing system 100 communicates with the provider device 708 and other client devices connected to the transportation matching system 704. As indicated by FIG. 7, the provider device 708 includes the transportation matching application 710. In many embodiments, the provider device network balancing system 100 communicates with the provider device 708 through the transportation matching application 710 to, for example, generate notifications to provide within a graphical user interface of the transportation matching application 710.

As indicated above, the provider device network balancing system 100 can provide (and/or cause the provider device 708 to display or render) visual elements within the graphical user interface associated with the transportation matching application 710. For example, the provider device network balancing system 100 can provide a notification for display within the transportation matching application 710.

Moreover, the provider device network balancing system 100 provides a user interface via the provider device 708 that includes selectable options for filtering the provider device network balance user interface based on various types of transportation requests (e.g., provider device indicators, requestor device indicators, a standard transportation request type, a time priority airport transportation request type, and/or a flexible time delay airport transportation request type), vehicle data inputs, and selections for viewing or dismissing notifications. The provider device network balancing system 100 can provide a user interface for provider requestor devices (e.g., a user interface that identifies one or more requestor devices and navigation instructions to fulfill transportation requests).

Although FIG. 7 illustrates the environment having a particular number and arrangement of components associated with the provider device network balancing system 100, in some embodiments, the environment may include more or fewer components with varying configurations. For example, in some embodiments, the provider device network balancing system 100 can communicate directly with the provider device 708, bypassing the network 716. In these or other embodiments, the provider device network balancing system 100 can be housed (entirely on in part) on the provider device 708. Additionally, the provider device network balancing system 100 can include or communicate with a database for storing information, such as various machine learning models, historical data (e.g., historical provider device and/or requestor device patterns), transportation requests, and/or other information described herein. Moreover, although FIG. 7 illustrates a single provider device 708, the provider device 708 is representative of a variety of client devices (e.g., thousands or millions of provider devices) that interact with the provider device network balancing system 100, and/or the transportation matching system 704.

Moreover, although not shown, the environment 700 further includes thousands or millions of requestor devices interacting with the transportation matching system 704. In particular, the provider device network balancing system 100 utilizes the data from the requestor devices interacting with the transportation matching system 704 to store it within the data for a number of requestor devices 714. For instance, the data of the requestor devices can include location data, ride preferences, recent pickups, cancelled requests, etc.

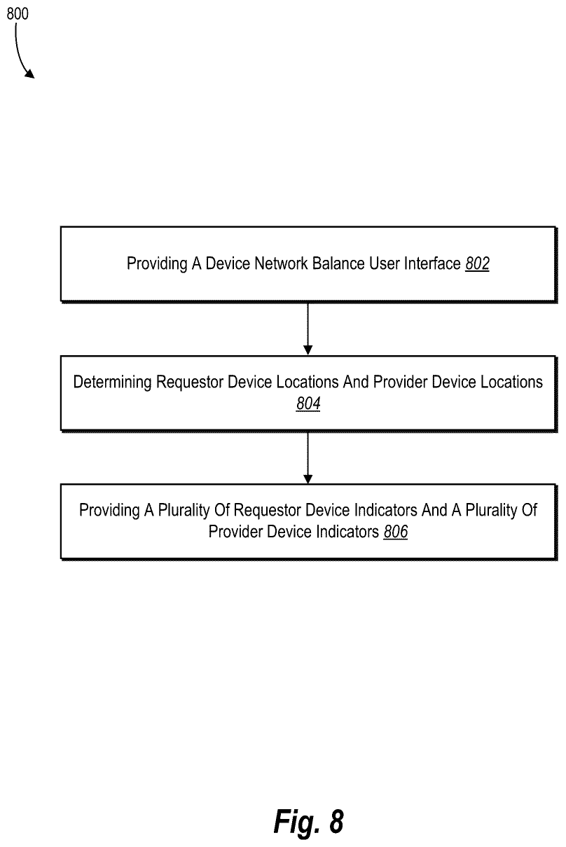

FIGS. 1-7, the corresponding text, and the examples provide a number of different systems, methods, and non-transitory computer readable media for generating and providing notifications. In addition to the foregoing, embodiments can also be described in terms of flowcharts comprising acts for accomplishing a particular result. For example, FIG. 8 illustrates a flowchart of an example sequence of acts in accordance with one or more embodiments.

While FIG. 8 illustrates acts according to some embodiments, alternative embodiments may omit, add to, reorder, and/or modify any of the acts shown in FIG. 8. The acts of FIG. 8 can be performed as part of a method. Alternatively, a non-transitory computer readable medium can comprise instructions, that when executed by one or more processors, cause a computing device to perform the acts of FIG. 8. In still further embodiments, a system can perform the acts of FIG. 8. Additionally, the acts described herein may be repeated or performed in parallel with one another or in parallel with different instances of the same or other similar acts.

FIG. 8 illustrates an example series of acts 800 for generating and providing a device network balance user interface with provider and requestor device indicators in accordance with one or more embodiments. As shown, the series of acts 800 includes an act 802 of providing a device network balance user interface, an act 804 of determining requestor device locations and provider device locations, and an act 806 of providing a plurality of requestor device indicators and a plurality of provider device indicators.

In one or more implementations, the act 802 further includes providing, for display via a provider device, a device network balance user interface comprising an interactive map of a geographic region; the act 804 further includes determining a plurality of requestor device locations for the geographic region and a plurality of provider device locations for the geographic region; and the act 806 further includes providing, for display within the device network balance user interface, a plurality of requestor device indicators corresponding to the plurality of requestor device locations and a plurality of provider device indicators corresponding to the plurality of provider device locations.

In one or more implementations, the series of acts 800 includes identifying a time threshold for the geographic region based on at least one of: a target number of requestor devices to display or a user interaction with a time threshold selection element via the provider device. Further, in one or more implementations, the series of acts 800 includes determining historical requestor devices transported by provider devices within the geographic region within the time threshold; and identifying pickup locations for the historical requestor devices transported by the provider devices to generate the plurality of requestor device locations.

In one or more embodiments, the series of acts 800 includes identifying a distance threshold for the geographic region based on at least one of a user interaction with a distance threshold selection element or a target number of provider devices to display. Furthermore, the series of acts 800 includes determining provider devices that fall within the distance threshold; and identifying locations for the provider devices that fall within the distance threshold.

In one or more embodiments, the series of acts 800 includes generating hashed driver identifiers for provider devices within the geographic region. Furthermore, the series of acts 800 includes providing the hashed driver identifiers to the provider device. In one or more embodiments, the series of acts 800 includes in response to detecting that the provider device has satisfied a threshold number of provider device queries withhold responses to an additional request for provider device locations. Furthermore, the series of acts 800 includes providing, for display via the interactive map of the device network balance user interface, a plurality of device network balance selectable elements corresponding to a plurality of geographic regions; and receiving a selection of a device network balance selectable element of the plurality of device network balance selectable elements.

In one or more embodiments, the series of acts 800 includes determining the plurality of device network balance selectable elements based on real-time data and historical data of the plurality of requestor device locations and the plurality of provider device locations for the geographic region. Furthermore, the series of acts 800 includes providing, for display within the device network balance user interface, a plurality of filters comprising a transportation matching mode filter, a vehicle type filter, and a wait-time filter; and in response to a selection of a filter from the plurality of filters, causing the device network balance user interface to display the plurality of requestor device indicators and the plurality of provider device indicators according to the filter.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 (e.g., the provider device 708, or the server(s) 706) that may be configured to perform one or more of the processes described above. One will appreciate that the provider device network balancing system 100 can comprise implementations of the computing device 900, including, but not limited to, the provider device 708 and/or the server(s) 706. As shown by FIG. 9, the computing device can comprise a processor 902, memory 904, a storage device 906, an I/O interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output interface 908 (or “I/O interface 908”), which are provided to allow a user (e.g., requestor or provider) to provide input to (such as user strokes), receive output from, and otherwise transfer data to and from the computing device 900. These I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that connects components of computing device 900 to each other.

FIG. 10 illustrates an example network environment 1000 of the transportation matching system 704. The network environment 1000 includes a client device 1006 (e.g., a provider device, a requestor device, additional the client device, or an infotainment device), a transportation matching system 704, and a vehicle subsystem 1008 connected to each other by a network 1004. Although FIG. 10 illustrates a particular arrangement of the client device 1006, the transportation matching system 704, the vehicle subsystem 1008, and the network 1004, this disclosure contemplates any suitable arrangement of client device 1006, the transportation matching system 704, the vehicle subsystem 1008, and the network 1004. As an example, and not by way of limitation, two or more of client device 1006, the transportation matching system 704, and the vehicle subsystem 1008 communicate directly, bypassing network 1004. As another example, two or more of client device 1006, the transportation matching system 704, and the vehicle subsystem 1008 may be physically or logically co-located with each other in whole or in part.

Moreover, although FIG. 10 illustrates a particular number of client devices 1006, transportation matching system 704, vehicle subsystems 1008, and networks 1004, this disclosure contemplates any suitable number of client devices 1006, transportation matching system 704, vehicle subsystems 1008, and networks 1004. As an example, and not by way of limitation, network environment 1000 may include multiple client device 1006, transportation matching system 704, vehicle subsystems 1008, and/or networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks 1004.

Links may connect client device 1006, provider device network balancing system 100, and vehicle subsystem 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 9. A client device 1006 may enable a network user at the client device 1006 to access network 1004. A client device 1006 may enable its user to communicate with other users at other client devices 1006.

In particular embodiments, the client device 1006 may include a requestor application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 704 may be a network-addressable computing system that can host a transportation matching network. The transportation matching system 704 may generate, store, receive, and send data, such as, for example, user-profile data, concept-profile data, text data, transportation request data, GPS location data, provider data, requestor data, vehicle data, or other suitable data related to the transportation matching network. This may include authenticating the identity of providers and/or vehicles who are authorized to provide transportation services through the transportation matching system 704. In addition, the transportation matching system 704 may manage identities of service requestors such as users/requestors. In particular, the transportation matching system 704 may maintain requestor data such as driving/riding histories, personal data, or other user data in addition to navigation and/or traffic management services or other location services (e.g., GPS services).

In particular embodiments, the transportation matching system 704 may manage transportation matching services to connect a user/requestor with a vehicle and/or provider. By managing the transportation matching services, the transportation matching system 704 can manage the distribution and allocation of resources from vehicle systems and user resources such as GPS location and availability indicators, as described herein.

The transportation matching system 704 may be accessed by the other components of network environment 1000 either directly or via network 1004. In particular embodiments, the transportation matching system 704 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 704 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or a transportation matching system 704 to manage, retrieve, modify, add, or delete, the information stored in data store.

In particular embodiments, the transportation matching system 704 may provide users with the ability to take actions on various types of items or objects, supported by the transportation matching system 704. As an example, and not by way of limitation, the items and objects may include transportation matching networks to which users of the transportation matching system 704 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 704 or by an external system of a third-party system, which is separate from transportation matching system 704 and coupled to the transportation matching system 704 via a network 1004.

In particular embodiments, the transportation matching system 704 may be capable of linking a variety of entities. As an example, and not by way of limitation, the transportation matching system 704 may enable users to interact with each other or other entities, or to allow users to interact with these entities through an application programming interfaces (“API”) or other communication channels.

In particular embodiments, the transportation matching system 704 may include a variety of servers, sub-systems, programs, modules, logs, and data stores. In particular embodiments, the transportation matching system 704 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requestor profile) store, connection store, third-party content store, or location store. The transportation matching system 704 may also include suitable components such as network interfaces, security mechanisms, load balancers, failover servers, management-and-network-operations consoles, other suitable components, or any suitable combination thereof. In particular embodiments, the transportation matching system 704 may include one or more user-profile stores for storing user profiles for transportation providers and/or transportation requestors. A user profile may include, for example, biographic information, demographic information, behavioral information, social information, or other types of descriptive information, such as interests, affinities, or location.

The web server may include a mail server or other messaging functionality for receiving and routing messages between the transportation matching system 704 and one or more client devices 1006. An action logger may be used to receive communications from a web server about a user's actions on or off the transportation matching system 704. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of the transportation matching system 704. A privacy setting of a user determines how particular information associated with a user can be shared. The authorization server may allow users to opt in to or opt out of having their actions logged by the transportation matching system 704 or shared with other systems, such as, for example, by setting appropriate privacy settings. Third-party-content-object stores may be used to store content objects received from third parties. Location stores may be used for storing location information received from client devices 1006 associated with users.

In addition, the vehicle subsystem 1008 can include a human-operated vehicle or an autonomous vehicle. A provider of a human-operated vehicle can perform maneuvers to pick up, transport, and drop off one or more requestors according to the embodiments described herein. In certain embodiments, the vehicle subsystem 1008 can include an autonomous vehicle—e.g., a vehicle that does not require a human operator. In these embodiments, the vehicle subsystem 1008 can perform maneuvers, communicate, and otherwise function without the aid of a human provider, in accordance with available technology.

In particular embodiments, the vehicle subsystem 1008 may include one or more sensors incorporated therein or associated thereto. For example, sensor(s) can be mounted on the top of the vehicle subsystem 1008 or else can be located within the interior of the vehicle subsystem 1008. In certain embodiments, the sensor(s) can be located in multiple areas at once—e.g., split up throughout the vehicle subsystem 1008 so that different components of the sensor(s) can be placed in different locations in accordance with optimal operation of the sensor(s). In these embodiments, the sensor(s) can include motion-related components such as an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requestor.

In particular embodiments, the vehicle subsystem 1008 may include a communication device capable of communicating with the client device 1006 and/or the provider device network balancing system 100. For example, the vehicle subsystem 1008 can include an on-board computing device communicatively linked to the network 1004 to transmit and receive data such as GPS location information, sensor-related information, requestor location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
providing, for display via a provider device, a device network balance user interface comprising an interactive map of a geographic region;
determining a plurality of requestor device locations for the geographic region and a plurality of provider device locations for the geographic region; and
providing, for display within the device network balance user interface, a plurality of requestor device indicators corresponding to the plurality of requestor device locations and a plurality of provider device indicators corresponding to the plurality of provider device locations.

2. The computer-implemented method of claim 1, wherein determining the plurality of requestor device locations comprises identifying a time threshold for the geographic region based on at least one of: a target number of requestor devices to display or a user interaction with a time threshold selection element via the provider device.

3. The computer-implemented method of claim 2, wherein determining the plurality of requestor device locations comprises:
determining historical requestor devices transported by provider devices within the geographic region within the time threshold; and
identifying pickup locations for the historical requestor devices transported by the provider devices to generate the plurality of requestor device locations.

4. The computer-implemented method of claim 1, wherein determining the plurality of provider device locations comprises identifying a distance threshold for the geographic region based on at least one of a user interaction with a distance threshold selection element or a target number of provider devices to display.

5. The computer-implemented method of claim 4, wherein determining the plurality of provider device locations comprises:
determining provider devices that fall within the distance threshold; and
identifying locations for the provider devices that fall within the distance threshold.

6. The computer-implemented method of claim 1, wherein providing the plurality of provider device indicators corresponding to the plurality of provider device locations comprises:
generating hashed driver identifiers for provider devices within the geographic region; and
providing the hashed driver identifiers to the provider device.

7. The computer-implemented method of claim 6, further comprising in response to detecting that the provider device has satisfied a threshold number of provider device queries withhold responses to an additional request for provider device locations.

8. The computer-implemented method of claim 1, further comprising identifying the geographic region by:
providing, for display via the interactive map of the device network balance user interface, a plurality of device network balance selectable elements corresponding to a plurality of geographic regions; and
receiving a selection of a device network balance selectable element of the plurality of device network balance selectable elements.

9. The computer-implemented method of claim 8, further comprising determining the plurality of device network balance selectable elements based on real-time data and historical data of the plurality of requestor device locations and the plurality of provider device locations for the geographic region.

10. A system comprising:
at least one processor; and
a non-transitory computer-readable medium comprising instructions that, when executed by the at least one processor, to cause the system to:
provide, for display via a provider device, a device network balance user interface comprising an interactive map of a geographic region;
determine a plurality of requestor device locations for the geographic region and a plurality of provider device locations for the geographic region; and
provide, for display within the device network balance user interface, a plurality of requestor device indicators corresponding to the plurality of requestor device locations and a plurality of provider device indicators corresponding to the plurality of provider device locations.

11. The system of claim 10, further comprising instructions that, when executed by the at least one processor, cause the system to determine the plurality of requestor device locations by identifying a time threshold for the geographic region based on at least one of: a target number of requestor devices to display or a user interaction with a time threshold selection element via the provider device.

12. The system of claim 11, further comprising instructions that, when executed by the at least one processor, cause the system to determine the plurality of requestor device locations by:
determining historical requestor devices transported by provider devices within the geographic region within the time threshold; and
identifying pickup locations for the historical requestor devices transported by the provider devices to generate the plurality of requestor device locations.

13. The system of claim 10, further comprising instructions that, when executed by the at least one processor, cause the system to determine the plurality of provider device locations by identifying a distance threshold for the geographic region based on at least one of a user interaction with a distance threshold selection element or a target number of provider devices to display.

14. The system of claim 13, further comprising instructions that, when executed by the at least one processor, cause the system to determine the plurality of provider device locations by:
determining provider devices that fall within the distance threshold; and
identifying locations for the provider devices that fall within the distance threshold.

15. The system of claim 10, further comprising instructions that, when executed by the at least one processor, cause the system to identify the geographic region by:
providing, for display via the interactive map of the device network balance user interface, a plurality of device network balance selectable elements corresponding to a plurality of geographic regions; and
receiving a selection of a device network balance selectable element of the plurality of device network balance selectable elements.

16. The system of claim 10, further comprising instructions that, when executed by the at least one processor, cause the system to:
provide, for display within the device network balance user interface, a plurality of filters comprising a transportation matching mode filter, a vehicle type filter, and a wait-time filter; and
in response to a selection of a filter from the plurality of filters, cause the device network balance user interface to display the plurality of requestor device indicators and the plurality of provider device indicators according to the filter.

17. A non-transitory computer-readable medium storing instructions that, when executed by at least one processor, cause a computing device to:
provide, for display via a provider device, a device network balance user interface comprising an interactive map of a geographic region;
determine a plurality of requestor device locations for the geographic region and a plurality of provider device locations for the geographic region; and
provide, for display within the device network balance user interface, a plurality of requestor device indicators corresponding to the plurality of requestor device locations and a plurality of provider device indicators corresponding to the plurality of provider device locations.

18. The non-transitory computer-readable medium of claim 17, further comprising instructions that, when executed by the at least one processor, cause the computing device to determine the plurality of requestor device locations by identifying a time threshold for the geographic region based on at least one of: a target number of requestor devices to display or a user interaction with a time threshold selection element via the provider device.

19. The non-transitory computer-readable medium of claim 18, further comprising instructions that, when executed by the at least one processor, cause the computing device to determine the plurality of requestor device locations by:
determining historical requestor devices transported by provider devices within the geographic region within the time threshold; and
identifying pickup locations for the historical requestor devices transported by the provider devices to generate the plurality of requestor device locations.

20. The non-transitory computer-readable medium of claim 17, further comprising instructions that, when executed by the at least one processor, cause the computing device determine the plurality of provider device locations by identifying a distance threshold for the geographic region based on at least one of a user interaction with a distance threshold selection element or a target number of provider devices to display.
